(19) United States
(12) Patent Application Publication
(10) Pub. No.: US 2014/0258008 A1
(43) Pub. Date: Sep. 11, 2014

(54) Systems, Methods, And Computer Program Products Providing Designation Of Money With An Account

(71) Applicant: EBAY INC., San Jose, CA (US)

(72) Inventors: Shailesh Dinkar Govande, Santa Clara, CA (US); Manabendra Paul, Bangalore (IN); Ravi Teja, Bangalore (IN); Madhura Pravin Tipnis, Santa Clara, CA (US)

(73) Assignee: EBAY INC., San Jose, CA (US)

(21) Appl. No.: 13/788,685

(22) Filed: Mar. 7, 2013

(51) Int. Cl. G06Q 20/40

(52) U.S. Cl. CPC G06Q 20/405
USPC 705/16; 705/39

(57) ABSTRACT

An electronic device includes: a memory storing instructions, and one or more processors in communication with the memory configured to execute the instructions to: create a segregated portion of a monetary account, the segregated portion being designated for use for a particular type of good or service, enforce segregation of the portion by denying use of money within the portion for goods or services different from the particular type of good or service.

### BACKGROUND

1. Technical Field

The present disclosure generally relates to making payments with electronic accounts, and more particularly, to techniques for enabling money within an account to be designated for a particular use.

2. Related Art

It is common for consumers and businesses to have electronically accessed accounts with financial institutions to send and receive payments from other parties. One example includes payment cards, which are typically used electronically and transfer money electronically. Another example is a third party payment provider, such as that offered under the name PayPal™, which processes payments between users who pay and receive funds to and from multiple sources such as payment cards, bank accounts, and other sources of funds for payment.

With electronic payment comes the ability to more easily track inflows and outflows. For example, with today's systems, users have the ability to “tag” a transaction after it has happened. Systems, such as Mint.com, give the user an ability to tag an expense after the transaction has already taken place. Such type of functionality is useful in budgeting purposes/tracking spending but it does not provide a way to control how funds are applied before a transaction takes place.

In comparison, systems such as 401k contributions in the United States allow a user to set aside certain portions of his/her salary to be deposited in a 401k account. Within this contribution, the user can also define an allocation, say 25% for mutual funds and 75% for equities. But the user can typically only rely on statements after the fact to make sure that the contributions are invested as per the defined allocation. The current system relies on the 401k provider to invest the user's money in accordance with his/her wishes. The user does not have the ability to “enforce” wishes on how money is invested, nor does it allow the user to designate money for specific purposes. Thus, there is no currently available technique within an electronic payment system for a user to make or enforce spending designations.

In another example, it is customary in India for an employer to pay for employee meals for salaried employees while at work. So companies in India separate the food allowance from the salary and provide food coupons or food cards for the allowance, which can be used only for purchasing food. Paper coupons can often be inconvenient to handle, though they provide a strict segregation of the food allowance from the salary. While some companies now offer electronic debit cards for the meal allowance, those debit cards are only accepted by a few vendors, and they require the employee to carry another card.

### BRIEF DESCRIPTION OF THE DRAWINGS

FIG. 1 is a block diagram illustrating an example system for transmission of funds from a transmitter to a receiver, according to one embodiment.

FIG. 2 is an illustration of an example relationship among the various components mentioned in the descriptions of FIG. 1, according to one embodiment.

FIG. 3 is a simplified block diagram of an example transmitter funding source according to one embodiment.

FIG. 4 illustrates an example method, adapted according to one embodiment, for making payments according to the principles discussed above with respect to FIGS. 1-3.

FIG. 5 illustrates a block diagram of an example computer system for implementing various methods and devices described according to various aspects of the present disclosure.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting.

According to the various aspects of the present disclosure, a method, system, and computer program product are discussed below that allow for funds in an electronic account to be designated for a specific purpose, and that purpose is enforced as transactions are attempted. In one example, a user has a debit or credit card with separate balances on the corresponding account. One balance is for a specific purpose (e.g., meals), and another balance is for general usage. Merchants with Point of Sale (POS) devices have the capability to accept the card and specify which balance to use during a transaction. In a scenario wherein a user desires to use the specific-purpose balance, a payment service provider or bank uses transaction information to determine whether a purchase properly fits within the specific purpose. The payment service provider or bank can then accept or reject the purchase or use general purpose funds, depending on whether the transaction is properly for the specific purpose and depending on available balances in the account.

In one example use case, a user has a balance of $100 in an account handled by a payment services provider, such as PayPal, Inc. Using one example embodiment, the user can tag $50 of his PayPal balance as “food”. Thus, the user sets aside $50 (from a total balance of $100) for transactions related to food. Now, suppose the user wants to buy an electronic item (worth $75) from a retailer and he wishes to pay for it using his account mentioned above. When the user proceeds with the payment, the backend financial system recognizes in real time that the transaction is for electronics. The system therefore understands that it cannot access the $50, which has been tagged for food. The system can then reject the user's payment for insufficient funds, (since only $50 is available for this transaction, the other $50 being marked as “food”) or resort to backup payment options.

In the example above, the user can tag the funds by applying metadata to the electronic funds or by applying metadata to the account to split the account into separate portions of money. In fact, any appropriate manner of creating separate balances within an electronic account are within the scope of embodiments. Furthermore, various techniques described below provide ways to recognize the goods/services involved in the transaction so that the payment service provider or bank may verify that a transaction is for (or not for) the specific purpose.

Another embodiment includes a student account that is created by a parent or guardian for use by a student. In this example, a parent can tag an amount in the student account to be only used for “school supplies”. When the student uses a debit or credit card associated with the account, the payment services provider or bank enforces the rule so that the school supply money can only be used for purchases related to school supplies.

In another example embodiment, a user donates money to an organization and wishes that his donations be used only for a specific purpose. For example a user may wish that his donation be used for providing relief to those affected by a recent natural calamity and not for any other purposes. The user can then tag his donation, say for example for “disaster relief”. When the organization spends money from its account, the idea proposed in this embodiment will ensure that the money donated by the user will only be spent on disaster relief efforts, and not on something else, by enforcing the tag that is associated with the money donated by the user. Such feature may be accomplished in any appropriate manner. In one example, the charity organization creates a segregated portion in one of its accounts, and the donor can transfer money to that portion. In another example, the electronic funds themselves are tagged with metadata indicating the specific purpose.

Thus, various embodiments provide for accounts that include more than one balance. Some embodiments allow a user to set aside a certain amount or percentage to be used on a particular type of good or service. The backend financial system at a bank or payment services provider can use transaction information to discern in real time (or near real time) whether a particular purchase can be paid for out of the segregated funds.

While the examples above discuss scenarios with a general purpose balance and one special-purpose balance, various embodiments may include any appropriate number of special-purpose balances in an electronic account. Also, the principles described herein can be applied to a debit account or a credit account. In a debit example, an amount of money within the account may be designated for a specific purpose. In a credit example, an amount of available credit may be designated for a specific purpose.

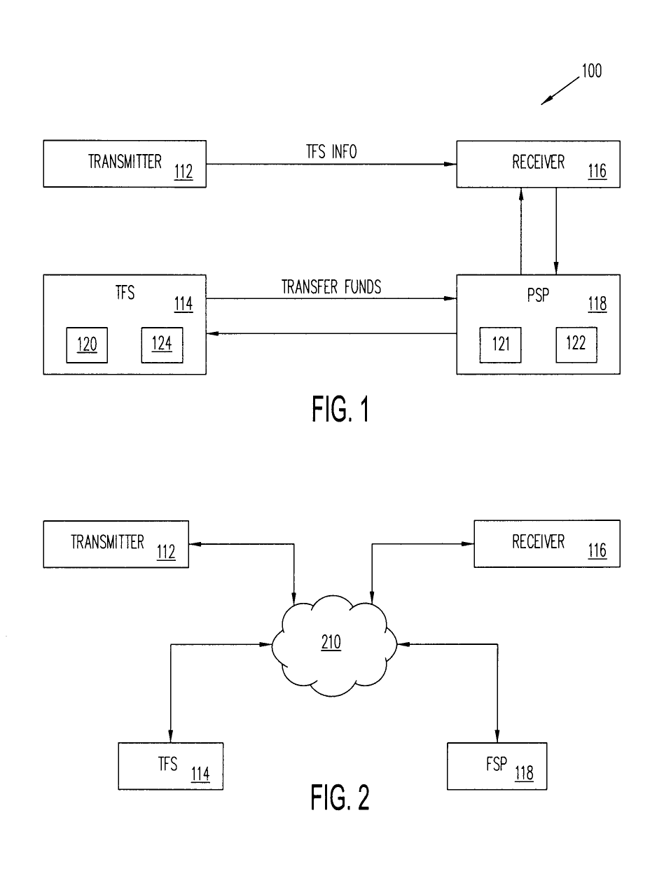

FIG. 1 is a block diagram illustrating an example system 100 for transmission of funds from a transmitter to a receiver, according to one embodiment. An example of a transmitter 112 is a customer or donor with an electronic financial account. An example of a receiver 116 is a merchant or charity that receives money from the transmitter 112. In one aspect, the transmitter 112 and the receiver 116 can be electronic devices representing each of the parties to the transaction. In one example, the transmitter 112 includes a smartphone, tablet computer, laptop computer, or the like, operable to transmit payment information (such as account credentials) to make payment electronically. In another example, the receiver 116 includes a POS system that receives payment information from transmitter 112 and sends the payment information on to FSP 118.

Payment Services Provider (PSP) 118 is a bank or other payment services entity, such as PayPal, Inc., which can send and receive funds and manage accounts. For instance, PSP 118 manages an account 121 for the receiver 116. Transmitter Funding Source (TFS) 112 is a also a bank or payment services entity that manages electronic account 120 on behalf of transmitter 112. Backend financial processes 122, 124 are processes running on one or more servers and include functionality to process payment and to recognize whether a transaction can be paid for out of a designated balance of account 120.

The transmitter 112 initiates the transaction by providing the TFS information to the receiver 116. The transaction is performed or completed through the electronic devices. The receiver 116 receives the TFS information, which may include credit card information or other financial information such as in the form of typical Automated Clearing House (ACH) messaging of a routing number, account number, check number or other funding source identification. The receiver 116 provides the TFS information with the receiver's PSP 118 to request the payment from the TFS 114. The PSP 118 includes information about a Receiver Account (RA) 121 for receiver 116. The PSP 118 communicates with the TFS 114 to facilitate the transfer of funds. In response, TFS 114 provides the payment, or transfer of funds, from account 120 to the receiver PSP 118. This processing may involve other parties during the communication between TFS 114 and PSP 118. The TFS 114 is an electronic system(s) that maintains accounts for users and has capability for communication with electronic systems used by other funding sources and payment service providers. The PSP 118 maintains the receiver's financial account 121, and includes an electronic system for communicating with electronic systems used by other payment service providers. Once the PSP 118 has received the transfer of funds, or a commitment that the funds are scheduled for transfer, the PSP 118 provides a confirmation to the receiver 116. The receiver 116 then provides such confirmation to the transmitter 112 and the transaction is complete.

In this example, account 120 includes general-purpose funds as well as specific-purpose funds. When PSP 118 requests payment from TFS 114, PSP 118 sends transaction information allowing backend process 124 to compare the transaction information to the specific purpose and to allow or disallow payment from the specific-purpose funds. Further in this example, the transaction information may originate at receiver 116 and be passed to backend process 122, where it is further passed to backend process 124.

In another example, PSP 118 and TFS 114 may be associated with the same entity. For instance, receiver 116 may use a payment services entity, such as PayPal, Inc., to process some or all of its payments, and the transmitter 112 may present account credentials for a credit or debit account managed by the same payment services entity. In such an instance, financial backend processes 122, 124 may be combined, and account 120 may be managed by PSP 118, such that PSP 118 provides functionality by itself to determine whether specific-purpose funds are used in the transaction. Any appropriate arrangement of PSP 118 and TFS 114 is within the scope of embodiments.

FIG. 2 is an illustration of an example relationship among the various components mentioned in the descriptions of FIG. 1 in a scenario in which both transmitter 112 and receiver 116 are processor-based devices that represent the parties to the transaction.

In this example, transmitter device 112 corresponds to the consumer's electronic device (e.g., such as a smartphone, laptop, tablet computer, etc.) that transmits account credentials to receiver 116). For instance, in a scenario in which a user orders goods/services online the user may present credentials electronically. Receiver device 116 corresponds to various computing resources associated with the payee or merchant (e.g., a POS or server computer). FSP 118 is an electronic system(s) that maintains the receiver's financial account, and includes an electronic system for communicating with electronic systems used by other financial service providers. TSP 114 is an electronic system(s) that maintains accounts for users and has capability for communication with electronic systems used by other funding sources and financial service providers. The various components 112-118 communicate with each other over communication network 210, which may include one or more networks, such as a cellular network, the Internet, and the like.

In another embodiment, a user may present a card to merchant POS terminal. In such an instance, the user may not be represented by an electronic device. The scope of embodiments is not limited to any technique for presenting credentials from a user to a merchant.

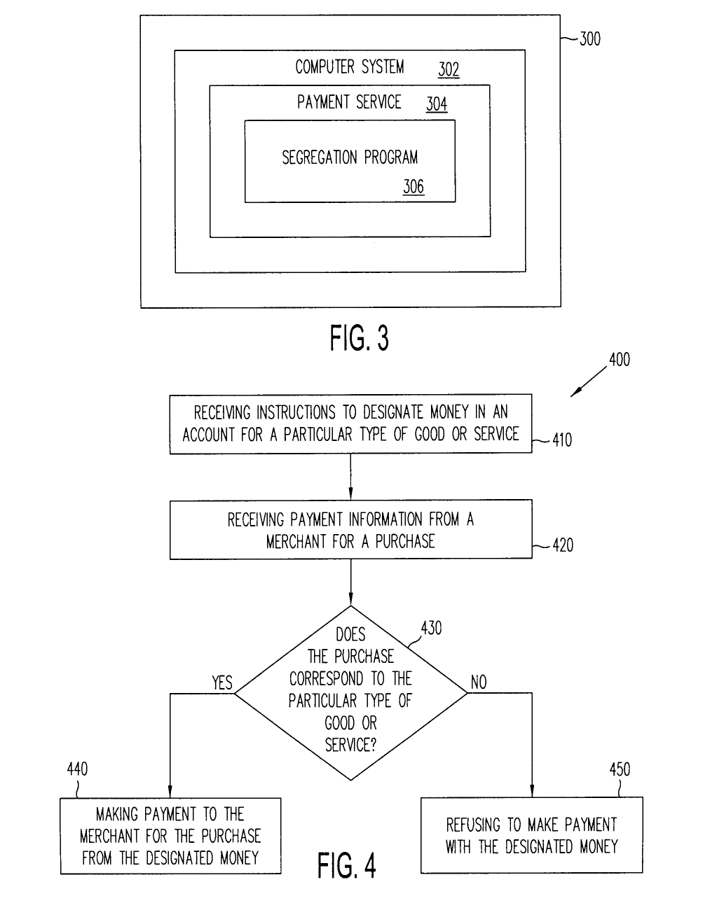

FIG. 3 is a simplified block diagram of an example transmitter funding source 300 according to various aspects of the present disclosure. The transmitter funding source, as explained above may be an organization that processes payments on behalf of the payor. Examples of transmitter funding sources include banks and other payment services entities. It is understood that in some examples the payment service provider and the transmitting funding source may be the same entity; thus, the principles of FIG. 3 may also apply to the payment services provider in such scenarios.

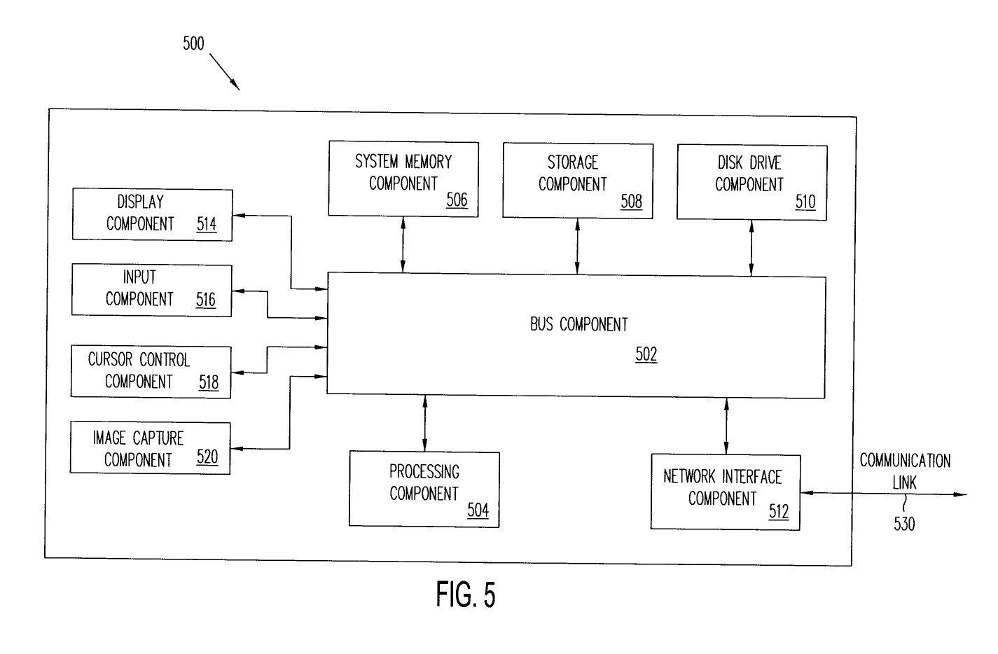

Transmitter funding source 300 includes computer system 302, which may be configured according to the example of FIG. 5 (described below), where one or more such computers may be programmed to receive payment instructions and to process payments accordingly. Computer system 302 has processors that execute computer-readable code to provide the functionality of payment service program 304. Payment service program 304 is a financial services backend program and includes functionality to make payments, both according to conventional techniques and according to the examples described above that include providing funds from a specific-purpose balance. For instance, payment service program 304 includes segregation program 306, which receives payee credentials and transaction information, discerns whether specific-purpose funds may be used, and then makes a payment for the payor to the payee accordingly, as described in more detail above.

Various embodiments include methods for making payment using the system shown in FIG. 1. FIG. 4 illustrates example method 400, adapted according to one embodiment, for making payments according to the principles discussed above with respect to FIGS. 1-3. The example of FIG. 4 is from the perspective of financial backend processes 122 and/or 124, and the actions of FIG. 4 may be performed by one or more computer processors at PSP 118 and/or TFS 114. One or more computer processors may execute code that provides the functionality described herein.

At block 410, the system receives instructions to designate money in an account for a particular type of good or service.

In one embodiment, block 410 includes receiving a command to apply data to the electronic account to segregate the account into two or more balances. At least one of the balances in the account includes general-purpose funds that can be used for any good or service. At least one other balance is for a specific purpose. Such command can be received from a person or a machine and may be from a holder of the account (e.g., a consumer), an entity depositing funds into the account (e.g., an employer), an entity managing the account (e.g., a bank or payment services provider), and/or the like. In one example use case, an employer provides an employee with a debit card, where the account corresponding to the debit card has a segregated portion already set up for a specific purpose. The employer then deposits money into the specific-purpose portion of the account (and perhaps into the general-purpose portion as well).

In another example use case, a parent sets up an account for a teenage son or daughter. In setting up the account, the parent designates a portion of the account for a specific purpose by applying data to the account to note that one portion of the account is for a specific purpose. In a debit scenario, money provided to the specific-purpose portion can be used for the specific purpose only. In a credit account scenario, remaining credit in the specific-purpose portion can only be used for the specific purpose.

In yet another use case, a donor donates money to a charity and inserts metadata into the electronic funds, the metadata specifying that the funds are for a specific purpose. By donating specific-purpose funds to the charity, the donor has caused the charity's bank to received instructions to designate money in the account for a particular good or service. In fact, while the example of FIG. 4 refers to a merchant and a purchase, the principles of FIG. 4 may be applied to any kind of transaction, such as a donation or a gratuitous transfer.

At block 420, the system receives payment information from a merchant for a purchase.

In one example use case, a consumer at a department store buys a variety of goods, including a meal. Further in this example, the user has an account that includes a portion that is designated for meals. An employee at the merchant scans the goods at a POS system, where bar codes or other designators identify each individual item to be purchased. The POS accesses a database based on the identified items to determine a cost of each item and a type of item. Thus, the POS system has information including item type and cost. Furthermore, the POS is capable of creating a variety of totals, e.g., a general total, a food total, a non-food total, and/or the like.

Continuing with the example use case, the user swipes a card or otherwise presents his or her account credentials to the merchant for payment. The user then requests to pay for the meal using the designated specific-purpose money in the account by, e.g. making a request on a touchpad or other use interface device at the POS. The POS sends the user's account credentials, transaction information, as well as information to identify the meal as a type of good (e.g. prepared food) and the cost of the meal, to the merchant's PSP. The PSP then sends a request for payment to the customer's TFS, including the information identifying the meal as a type of good and the cost of the meal. Thus, the customer's TFS receives payment information from the merchant for a purchase, and the TFS can decide whether the requested meal purchase qualifies for payment from the specific-purpose money.

In a related example use case, the merchant's PSP knows that the merchant is identified as a seller of specific goods or services because the merchant identified itself as a seller of specific goods or services when it registered to receive electronic payments at its POS. For instance, a restaurant may be designated as a restaurant by its PSP. In such embodiments, the merchant designation may be used as a type of identifying data that can be used by the TFS to determine whether to allow for payment out of specific-purpose funds.

At block 430, the TFS discerns whether the purchase corresponds to the particular type of good or service. For instance, in one example, the TFS compares the specific type of good or service, as it was designated at block 410, to the information that was passed by the merchant's POS (via the PSP) regarding the type of good or service. Thus, if the designated money in the account is for meals, and the information sent by the merchant indicates that the purchase is for a “meal” type of good, then the TFS may allow for payment for the meal using specific-purpose funds at block 440.

On the other hand, if the good/service type does not match well with the designation of the money, or if there is not sufficient funds in the designated money to pay for the purchase, the TFS may refuse to make payment for the item with the designated money (at block 450).

In some instances, at block 450, the TFS may apply other funds, such as general-purpose funds, to the purchase. In other instances, the TFS may decline the purchase outright, such as in a case of insufficient funds in the general-purpose funds. Furthermore, in some instances, a payment from the specific-purpose funds may be handled as a separate transaction from a purchase of the other goods out of other funds in the electronic account, or as a same transaction. Whether the TFS permits or declines use of the designated money, the PSP forwards a message to the merchant's POS that the transaction is confirmed or declined.

The scope of embodiments is not limited to the particular flow shown in FIG. 4. Rather, other embodiments may add, omit, rearrange, or modify one or more actions in accordance with a given design. For instance, other embodiments may include repeating the actions of blocks 420-450 whenever the user attempts to use the specific-purpose funds. Additionally, the method 400 may also include using general-purpose funds to pay for other items, whether or not specific-purpose funds are permitted to be used for one or more requested items.

It should also be noted, as mentioned above, that in some embodiments, the merchant's PSP is the same as the TFS (e.g., when the merchant uses PayPal, Inc. as a payment services provider and where the customer uses a card issued by PayPal, Inc.). In such embodiments, the actions of blocks 410-450 may be performed by the PSP/TFS.

Moreover, while the examples above refer to using a debit card or credit card that can be swiped, the scope of embodiments is not so limited. Rather, the principles described above can be applied to embodiments whereby a user transmits account credentials using a wireless technology such as Near Field Communication (NFC) or to other kinds of card technology, such as Chip-and-PIN cards.

It was mentioned above that some embodiments may apply metadata to funds in the account to restrict how the funds may be used. Such embodiments may also include additional metadata associated with the funds which specifies a cut-off date within which the funds must be used. If the cut-off date expires, the funds are returned to the user. The user has the ability to extend the cut-off date. One example includes a user who donates money to a charity. The user wants that the money be spent as soon as possible to provide relief to people affected by a natural disaster. So in this case, the user can specify the “cut-off date” for the money to be used, say fifteen days from the original date of transfer (or any appropriate date). If the charity does not spend the money within those fifteen days, the money is automatically credited back to user's account or applied to another purpose of the user's choice.

Metadata tags applied to funds may be removed once the money is transferred from the restricted portion of the account to an authorized use. In one example, the backend financial system itself removes the metadata tags. The system can make the decision in real time, and when the money is spent for an approved purpose, the backend financial system removes the tag in real time (or near real time). For example, if a user is spending the money allocated for “electronics” tag at an electronics store, the financial system can recognize this fact and remove the tag in real time so that the tag does not persist after the money is transferred to the account of the merchant. In other examples, the user to whom the money belongs, and anyone authorized by the user, may remove the metadata tag.

Various embodiments may provide one or more advantages over current systems. For instance, some embodiments allow an entity to create a segregated portion of a monetary account for use for a particular type of good or service and then to enforce the segregation by denying use of the money for different goods or services, as explained above with respect to FIG. 4. Thus, various embodiments allow for control of funds before those funds are used and in a way that consistent and enforceable for different transactions.

FIG. 5 is a block diagram of a computer system 500 suitable for implementing various methods and devices described herein, for example, the various methods may be performed by a server computer or other type of computer that can be used as part of an account management or payment processing infrastructure at a PSP or TFS. Accordingly, it should be appreciated that such devices may be implemented as the computer system 500 for communication with a network in a manner as follows.

In accordance with various embodiments of the present disclosure, the computer system 500 includes a bus component 502 or other communication mechanisms for communicating information, which interconnects subsystems and components, such as processing component 504 (e.g., processor, micro-controller, digital signal processor (DSP), etc.), system memory component 506 (e.g., RAM), static storage component 508 (e.g., ROM), disk drive component 510 (e.g., magnetic or optical), network interface component 512 (e.g., modem or Ethernet card), display component 514 (e.g., touch-screens, cathode ray tube (CRT) displays, or liquid crystal display (LCD)), input component 516 (e.g., keyboard or touch-sensitive components operable to detect a touch by a human body), cursor control component 518 (e.g., mouse or trackball), and image capture component 1120 (e.g., analog or digital camera). In one implementation, disk drive component 510 may comprise an array having one or more disk drive components or solid-state drive components.

In accordance with embodiments of the present disclosure, computer system 500 performs specific operations by processor 504 executing one or more sequences of one or more instructions contained in system memory component 506. Such instructions may be read into system memory component 506 from another computer readable medium, such as static storage component 508 or disk drive component 510. In other embodiments, hard-wired circuitry may be used in place of (or in combination with) software instructions to implement the present disclosure.

Logic may be encoded in a computer readable, non-transitory medium, which may refer to any medium that participates in providing instructions to processor 504 for execution. Such a medium may take many forms, including but not limited to, non-volatile media and volatile media. In various implementations, non-volatile media includes optical or magnetic disks, such as disk drive component 510, and volatile media includes dynamic memory, such as system memory component 506.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 530 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 530 and communication interface 512. Received program code may be executed by processor 504 as received and/or stored in disk drive component 510 or some other storage component for execution.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be appreciated that like reference numerals are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. An electronic device comprising:
a memory storing instructions; and
one or more processors in communication with the memory configured to execute the instructions to:
create a segregated portion of a monetary account, the segregated portion being designated for use for a particular type of good or service and being segregated from general-purpose funds of the monetary account; and
enforce segregation of the portion by denying use of money within the portion for goods or services different from the particular type of good or service.

2. The electronic device of claim 1, wherein the one or more processors create the segregated portion by:
associating metadata with electronic funds, the metadata designating the electronic funds for use for the particular type of good or service.

3. The electronic device of claim 2, wherein the one or more processors create the segregated portion by:
receiving the electronic funds from a third party with the metadata associated with the electronic funds.

4. The electronic device of claim 1, wherein the one or more processors create the segregated portion by:
associating metadata with the account, the metadata indicating the particular good or service and an amount of the portion.

5. The electronic device of claim 1, wherein the electronic device is associated with a payment services provider of a holder of the account, the payment services provider being different from a bank.

6. The electronic device of claim 1, wherein the electronic device is associated with a bank of a holder of the account.

7. The electronic device of claim 1, wherein the processors are further operable to execute instructions to:
permit use of money within the portion for goods or services that correspond to the particular type of good or service.

8. A method performed by a computer system, the method comprising:
receiving by the computer system instructions to designate money in an account for a particular type of good or service;
receiving by the computer system payment information from a payee for a transaction;
discerning by the computer system whether the transaction corresponds to the particular type of good or service; and
making by the computer system payment to the payee for the transaction, where payment is made from designated money within the account in response to discerning that the transaction corresponds to the particular type of good or service, the designated money being segregated from general-purpose funds.

9. The method of claim 8, wherein the method is performed by a payment services provider of a payor.

10. The method of claim 8, wherein the method is performed by a bank associated with a payor.

11. The method of claim 8, wherein receiving payment information comprises:
receiving information from a payee Point of Sale (POS) that identifies a payment amount of the transaction and an indication of a type of good or service of the transaction.

12. The method of claim 8, wherein receiving payment information comprises:
receiving information that identifies the payee as a seller of the particular type of good or service.

13. The method of claim 8, wherein the received instructions are received from a payor.

14. The method of claim 8, further comprising:
denying a subsequent attempted purchase for other goods or services in response to discerning that the other goods or services do not correspond to the particular type of good or service.

15. A computer program product having a non-transitory computer readable medium tangibly recording computer program logic for managing electronic payment, the computer program product comprising:
code to receive instructions to designate money in an account for a particular type of good or service;
code to receive payment information from a payee for a transaction;
code to discern whether the transaction corresponds to the particular type of good or service; and
code to make payment to the payee for the transaction, where payment is made from designated money within the account in response to discerning that the transaction corresponds to the particular type of good or service, the designated money being segregated from general-purpose funds.

16. The computer program product of claim 15, wherein a payment services provider of a payor manages the electronic payment.

17. The computer program product of claim 8, wherein a bank associated with a payor manages the electronic payment.

18. The computer program product of claim 8, wherein the code to receive payment information comprises:
code to receive information from a payee Point of Sale (POS) that identifies a payment amount of the transaction and an indication of a type of good or service of the transaction.

19. The computer program product of claim 8, wherein the code to receive payment information comprises:
code to receive information that identifies the payee as a seller of the particular type of good or service.

20. The computer program product of claim 8, further comprising:
code to deny a subsequent attempted purchase for other goods or services in response to discerning that the other goods or services do not correspond to the particular type of good or service.
